(19) United States
(12) Patent Application Publication
(10) Pub. No.: US 2009/0040259 A1
(43) Pub. Date: Feb. 12, 2009

(54) INKJET IMAGE FORMING APPARATUS

(75) Inventors: Nam Kyun KIM, Seongnam-si (KR); Eun Bong HAN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/132,037

(22) Filed: Jun. 3, 2008

(30) Foreign Application Priority Data
Aug. 6, 2007 (KR) 2007-78443

(51) Int. Cl. B41J 29/38

(52) U.S. Cl. 347/17

(57) ABSTRACT

An inkjet image forming apparatus includes a stabilization circuit to stabilize operations of a thermal shutdown circuit simultaneously restricting noise induced in a thermal shutdown circuit. The stabilization circuit includes a pair of PMOSFETs. The PMOSFETs are connected between a power-supply signal of the thermal shutdown circuit and a ground terminal, and serve as a current source and a resistor. The voltage applied to a gate of the pair of PMOSFETs is equal to a voltage applied to the thermal shutdown circuit, so that a circuit configuration is simplified. This voltage is higher than a minimum turn-on voltage of the PMOSFETs, and current signals flowing in the pair of PMOSFETs are approximately equal to each other.

### CROSS-REFERENCE TO RELATED APPLICATIONS

This application claims priority under 35 U.S.C. §119(a) from Korean Patent Application No. 2007-0078443, filed on Aug. 6, 2007 in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus to prevent a printer head from overheating.

2. Description of the Related Art

Generally, the inkjet printer head can be classified into a thermal-driving inkjet printer head based on an injection mechanism of ink bubbles and an inkjet printer head based on a piezoelectric driving scheme. The ink-bubbles injection mechanism of the inkjet printer head based on the thermal-driving scheme will hereinafter be described.

If a pulse-shaped current signal flows in a heater composed of a resistance-heating material, the heater generates heat, so that ink adjacent to the heater is instantaneously heated up to about 300° C. Therefore, ink bubbles occur, the bubbles are increased, so that the increased bubbles apply pressure to an inside of the ink chamber fully filled with the ink. The ink adjacent to the nozzle is configured in a form of ink bubbles via the nozzle, and ink droplets are sprayed out of the ink chamber.

A method to operate the printer head of the inkjet image forming apparatus is classified into a shuttle scheme and a line-printing scheme. The line-printing scheme moves only the printing medium on a condition that the printer head including the nozzle corresponding to a width of the printing medium is fixed, so that a desired image is printed.

Before starting a printing process, a substrate is heated to warm the ink contained in the ink chamber, by a sub-heater mounted to a substrate in a vicinity of the ink chamber, so that a pre-process of the printing process is completed.

Ink temperature information is required (e.g., the substrate is heated or a long period of the printing process is conducted), and a temperature sensor is mounted to the head chip of the printer head. The ink temperature is measured by the temperature sensor.

The above-mentioned temperature sensor is used to monitor the ink temperature. Based on the measured ink temperature, the printing process is properly controlled.

The temperature sensor to monitor the ink temperature is contained in the printer head, so that the temperature of the printer head may be measured by the temperature sensor. If erroneous operations of the temperature sensor occur, the temperature-measurement information cannot be trusted, so that there is a need to provide against the erroneous phenomenon to excessively increase the temperature of the printer head without relying on the temperature sensor.

In addition to the temperature-measurement operation based on the temperature sensor, the head chip must include a thermal shutdown circuit to prevent the printer head from being overheated.

A missing nozzle having poor ink-discharging characteristics or a dead nozzle caused by the modified nozzle in the manufacturing process of the printer head may occur. The dead zone has difficulty in normally spraying the ink, and foreign material is caught in the nozzle holes of the head chip. In this case, the printer head may overheat due to an abruptly-increasing temperature, so that the printing process must be controlled by the thermal shutdown circuit to prevent the printer head from being overheated.

The thermal shutdown circuit measures the temperature of the printer head using the temperature-measurement resistor manufactured by the semiconductor process, and compares the temperature-measurement voltage corresponding to the measured temperature with a reference voltage to prevent an occurrence of overheating. If the printer head is overheated, the thermal shutdown circuit outputs a heater-stoppage signal, and the heater-stoppage signal is applied to the reset terminal of the circuit block generating the fire pulse driving the heater, so that the heating operation of the heater is stopped.

However, if the noise is received in the thermal shutdown circuit, the temperature-measurement voltage and the reference voltage are negatively affected by the noise. Consequently, the comparison result is unexpectedly changed. In this way, the original functions of the thermal shutdown circuit cannot be normally conducted.

### SUMMARY OF THE INVENTION

The present general inventive concept provides an inkjet image forming apparatus to prevent a thermal shutdown circuit from being erroneously operated due to noise.

The present general inventive concept also provides an inkjet image forming apparatus to reduce an amount of power consumption to prevent a thermal shutdown circuit from being erroneously operated, resulting in reduction of total power consumption.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an inkjet image forming apparatus including a thermal shutdown circuit to output a heater control signal to control an operation of a heater contained in a head chip according to a temperature-measurement result of the head chip, and a stabilization circuit to restrict noise induced in the thermal shutdown circuit, and to stabilize operations of the thermal shutdown circuit.

The stabilization circuit may be mounted to a power-supply line connected between a power-supply unit of the thermal shutdown circuit and a ground terminal.

The stabilization circuit may include a circuit element to serve as a current source and a resistor.

The circuit element may include at least one PMOSFET, a gate to receive a power-supply voltage of the thermal shutdown circuit and an additional bias voltage.

The bias voltage may be applied to a comparator to compare a temperature-measurement voltage with a reference voltage in the thermal shutdown circuit.

The bias voltage may be less than the power-supply voltage and may be higher than a minimum turn-on voltage of the PMOSFET.

If a plurality of PMOSFETS are connected to a plurality of power-supply lines sharing the power-supply voltage, respectively, the bias voltage may implement a same current signal flowing in the PMOSFETs connected to the power-supply lines.

The thermal shutdown circuit may include a temperature-measurement unit to generate a temperature-measurement voltage using first and second temperature-measurement resistors serially connected to a first power-supply line connected between the power-supply voltage and the ground terminal, a reference-voltage setup unit to generate a reference voltage using first and second voltage-division resistors serially connected to a second power-supply line connected between the power-supply voltage and the ground terminal independent of the first power-supply line, and a comparator to generate a heater-stoppage signal according to a difference between the temperature-measurement voltage of the temperature-measurement unit and the reference voltage of the reference-voltage setup unit, in which the circuit element is connected to the first and second power-supply lines.

The thermal shutdown circuit may further include a hysteresis-characteristic unit to receive an output signal of the comparator as a feedback signal, and to adjust the reference voltage, and the circuit element extends a hysteresis margin associated with the reference voltage such that the hysteresis margin is determined by the hysteresis-characteristic unit.

The foregoing and/or other aspects and utilities of the general inventive concept may also be achieved by providing an inkjet image forming apparatus including a thermal shutdown circuit to generate a heater-stoppage signal to stop operations of a heater according to a result of comparison between a temperature-measurement voltage measured by a head-chip equipped with at least one heater and a reference voltage to prevent the head-chip from overheating, and a stabilization circuit to restrict noise induced in the thermal shutdown circuit, and to stabilize operations of the thermal shutdown circuit.

The stabilization circuit may further include a bias-voltage provider to connect a PMOSFET serving as both a current source and a resistor to each of power-supply lines of the thermal shutdown circuit, and to provide a gate of the PMOSFET with a bias voltage applied to the gate of the PMOSFET, in which the bias-voltage provider provides a same bias voltage for use in the thermal shutdown circuit.

The foregoing and/or other aspects and utilities of the general inventive concept may also be achieved by providing an inkjet image forming apparatus including a plurality of nozzles, an ink storage chamber to store ink, and one or more heaters to heat the ink and eject ink droplets from the plurality of nozzles, wherein the one or more heaters shutoff when a temperature-measurement voltage is higher than a reference voltage.

The foregoing and/or other aspects and utilities of the general inventive concept may also be achieved by providing a method to prevent overheating of an inkjet image forming apparatus, the method including determining a voltage difference between a temperature-measurement voltage corresponding to a measured temperature and a reference voltage corresponding to a reference voltage, output a heater-stoppage signal to one or more heaters based on the determined voltage difference, and shutting off the one or more heaters in response to receiving the heater-stoppage signal.

The foregoing and/or other aspects and utilities of the general inventive concept may also be achieved by providing a computer-readable recording medium having embodied thereon a computer program to execute a method, wherein the method including determining a voltage difference between a temperature-measurement voltage corresponding to a measured temperature and a reference voltage corresponding to a reference voltage, output a heater-stoppage signal to one or more heaters based on the determined voltage difference, and shutting off the one or more heaters in response to receiving the heater-stoppage signal.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a circuit diagram illustrating a thermal shutdown circuit to prevent a printer head of an inkjet image forming apparatus from overheating and a stabilization circuit to prevent erroneous operations of the thermal shutdown circuit according to an embodiment of the present general inventive concept;

FIG. 2 illustrates a temperature-measurement voltage and a reference voltage on the condition that no noise occurs in the inkjet image forming apparatus according to an embodiment of the present general inventive concept;

FIG. 3 illustrates a consumed current of an improved circuit according to an embodiment of the present general inventive concept;

FIG. 4 illustrates a simulation result of a temperature-measurement voltage and noise when first noise is received according to an embodiment of the present general inventive concept;

FIG. 5 illustrates a simulation result of a temperature-measurement voltage and noise when second noise is received according to an embodiment of the present general inventive concept;

FIG. 6 illustrates the simulation result of a temperature-measurement voltage and noise when third noise is received according to an embodiment of the present general inventive concept;

FIG. 7 illustrates a table of a noise-voltage difference and a hysteresis margin according to an embodiment of the present general inventive concept; and

FIG. 8 is a flowchart illustrating a method to prevent overheating of an inkjet image forming apparatus according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below to explain the present general inventive concept by referring to the figures.

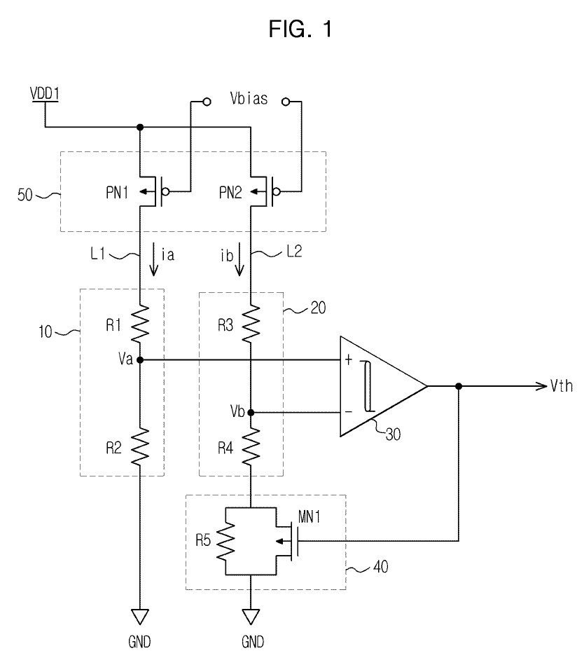

Referring to FIG. 1, the inkjet image forming apparatus according to an embodiment of the present general inventive concept includes a thermal shutdown circuit and a stabilization circuit 50. The thermal shutdown circuit and the stabilization circuit 50 are contained in a head chip mounted to a printer head (not illustrated) by a semiconductor process.

The thermal shutdown circuit includes a temperature-measurement unit 10, a reference-voltage setup unit 20, a comparator 30, and a hysteresis-characteristic unit 40.

The temperature-measurement unit 10 includes first and second temperature-measurement resistors R1 and R2 serially connected to a first power-supply line connected between the power-supply voltage (VDD1) and the ground terminal (GND). A connection point of the first and second temperature-measurement resistors R1 and R2 is connected to a non-inverting terminal (+) of the comparator 30, and the voltage of the connection point is used as a temperature-measurement voltage (Va).

The reference-voltage setup unit 20 includes first and second voltage-division resistors R3 and R4 serially connected to a second power-supply line (L2) connected between the power-supply voltage (VDD1) and the ground terminal (GND) independent of the first power-supply line (L1). A connection point of the first and second voltage-division resistors R3 and R4 is connected to an inverting terminal (−) of the comparator 30, and the voltage of the connection point is used as a reference voltage (Vb).

The comparator 30 outputs a heater-stoppage signal (Vth) based on a difference between the temperature-measurement voltage (Va) received from the temperature-measurement unit 10 and the reference voltage (Vb) received from the reference-voltage setup unit 20. For example, if the measurement temperature is higher than a reference voltage so that the printer head is overheated, the comparator 30 outputs a heater-stoppage signal of the “HIGH” level.

The heater-stoppage signal (Vth) is applied to a heater-driving circuit block (not illustrated) to generate a fire pulse to drive a heater. Upon receiving the high-level heater-stoppage signal, the heater-driving circuit block is reset so that the heater-driving circuit block stops driving the heater, so that the temperature of the printer head is gradually lowered. As the temperature of the printer head is gradually decreased, the temperature-measurement voltage (Va) is changed. So, if the measurement temperature is equal to or less than a reference voltage, the comparator 30 transmits a heater-stoppage signal of the “LOW” level to the heater-driving circuit block. Upon receiving the heater-stoppage signal of the LOW level, the heater-driving circuit block drives the heater and performs a respective printing operation.

The hysteresis-characteristic unit 40 includes a resistor R5 which is serially connected to the second voltage-division resistor R4 of the reference-voltage setup unit 20, and an NMOSFET (MN1) which is connected in parallel to the resistor R5 and receives an output signal of the comparator 20 as a feedback signal. As a result, the hysteresis-characteristic unit 40 has hysteresis characteristics to adjust the reference voltage (Vb) according to a measurement temperature.

Upon receiving noise from the power-supply voltage (Vdd1), the temperature-measurement voltage (Va) received in the non-inverting terminal (+) and the reference voltage (Vb) received in the inverting terminal (−) may be unstable. IN order to effectively cope with an unstable operation status, the output signal of the comparator 30 must not be affected by noise. For this purposes, a hysteresis-characteristic range, i.e., a hysteresis margin, needs to be widely extended.

In order to cope with the reception of noise, the present embodiment includes a stabilization circuit 50 located among the power-supply voltage (VDD1), the temperature-measurement unit 10, and the reference-voltage setup unit 20.

The stabilization circuit 50 includes a first PMOSFET (PM1) serially connected between the power-supply voltage (VDD1) and the first temperature-measurement resistor (R1) and a second PMOSFET (PM2) connected between the power-supply voltage (VDD1) and the first voltage-division resistor (R3).

The first PMOSFET (PM1) and the second PMOSFET (PM2) serve as a current source and a resistor, so that the first PMOSFET (PM1) and the second PMOSFET (PM2) can serve as a noise filter to restrict the noise received via the first and second power-supply lines L1 and L2. In addition, the hysteresis margin of the hysteresis-characteristic unit 40 can be further extended.

Gates of the first PMOSFET (PM1) and the second PMOSFET (PM2) receive the bias voltage (Vbias). An additional external power-supply signal may be applied to the bias voltage (Vbias), however, an additional circuit to process external power-supply signals is further required. The present embodiment simplifies the circuit configuration by applying the bias voltage (Vbias) to the comparator 30.

The voltage level of the bias voltage (Vbias) may be set to be less than the power-supply voltage (VDD1). In this case, if the bias voltage is very high, power consumed in the first and second PMOSFETs PM1 and PM2 increases. If the bias voltage is very low, the first PMOSFET (PM1) and the second PMOSFET (PM2) are not turned on. Therefore, the voltage level of the bias voltage (Vbias) can be decided in consideration of the above-mentioned conditions. In the case of deciding the bias-voltage level, a first driving current (Ia) flowing in the first power-supply line (L1) can be almost equal to a second driving current (ib) flowing in the second power-supply line (L2), so that the bias-voltage level does not affect the comparison between the temperature-measurement voltage and the reference voltage in the thermal shutdown circuit.

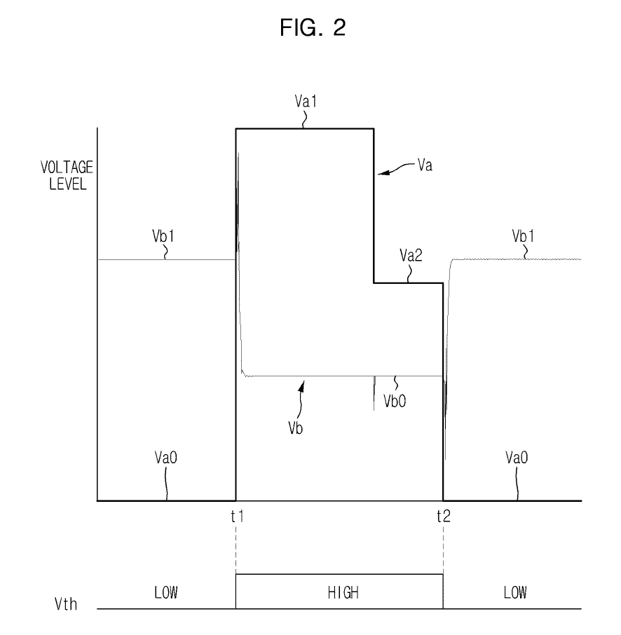

If the thermal shutdown circuit does not receive the noise and the temperature-measurement voltage (Va) is higher than the reference voltage (Vb) as illustrated in FIG. 2, the comparator 30 outputs the heater-stoppage signal of the HIGH level. If the temperature-measurement voltage (Va) is not higher than the reference voltage (Vb), the comparator 30 outputs the heater-stoppage signal of the LOW level.

For example, an embodiment of the present general inventive concept, the bias voltage (Vbias) of about 2.3V is applied to the gate of each of the first and second PMOSFETs PM1 and PM2 of the stabilization circuit 50. In this case, a minimum turn-on voltage (|Vgs|) of each of the first and second PMOSFETs PM1 and PM2 is set to 1V.

In the present embodiment, a sheet resistance of each of the resistors R1, R2, and R4 at normal temperature is 6.53 Ω/square, and the sheet resistance of the resistor (R3) is 78.68 Ω/square. A voltage level of the temperature-measurement voltage (Va) is set to 0.540 V (See “Va0” of FIG. 2), and a voltage of the reference voltage (Vb) is set to 0.618 V (See “Vb1” of FIG. 2). The output voltage (Vth) of the comparator 30 enters the LOW status via the status of Va<Vb.

If the head-chip temperature is set to 120° C., the voltage “Va” is set to 0.619V (See “Va1” of FIG. 2) according to a variation of the sheet resistance of each of the resistors R1 and R2, and the voltage “Vb” remains without any change. In this case, the output voltage (Vth) of the comparator 30 via the status of Va>Vb, is changed to the high level (See “t1” of FIG. 2). Therefore, the heater-driving circuit block to generate the fire pulse in the heater is reset, so that the heater stops operation.

Since the output voltage (Vth) of the comparator 30 is changed to the high level, the NMOSFET (MN1) receiving a feedback input signal of the comparator 30 is turned on, so that the reference voltage (Vb) drops from 0.619V (See “Vb1” of FIG. 2) to 0.580V (See “Vb0” of FIG. 2)

Thereafter, as the head-chip temperature is gradually decreased, the temperature-measurement voltage (Va) is also changed as denoted by “Va1=>Va2”. If the head-chip temperatures drops to a normal temperature (e.g., 60° C.), the reference voltage (Vb) is maintained at 0.618V (Vb1). As the temperature-measurement voltage (Va) drops to 0.540V, the output voltage (Vth) of the comparator 30 enters the low level, so that the NMOSFET (MN1) is turned off (See “t2” of FIG. 2).

As described above, for example, a voltage difference in the reference voltage (Vb) changing with temperature is 38 mv, as denoted by Vb1−Vb0=0.618-0.580V. This voltage difference is higher than that of the conventional art. Therefore, the hysteresis margin to prevent the influence of noise can be extended.

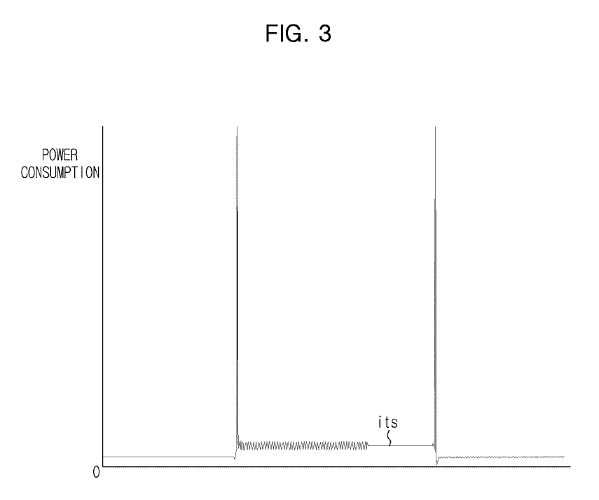

If the consumption current under the condition that the improved circuit of FIG. 1 is operating is set to 0.320 mA (See “its” of FIG. 3), for example, the consumption power is about 1.056 mW.

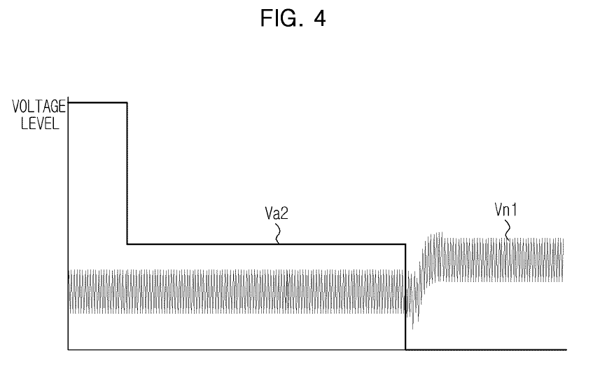

FIGS. 4 to 6 illustrate simulation results of the temperature-measurement voltage and the noise under the first to third noise status having different voltages (i.e., peak-to-peak voltages) of the improved circuit.

As illustrated in FIG. 4, if the voltage difference of the first noise (Vn1) is applied to the improved circuit enters the first noise (Vn1), since the first noise is not higher than the temperature-measurement voltage (Va2), the operations of the comparator 30 is not affected by the first noise. As described above, the output voltage (Vth) of the comparator 30 is changed to the high status, so that the head-chip temperature gradually drops to the voltage of “Va2”. In this case, although the first noise (Vn1) having the voltage difference of 200 mv is received by the comparator 30, the comparator 30 is not affected by the first noise (Vn1).

That is, the comparator 30 continuously maintains the high status, and the head-chip temperature is further decreased, so that the voltage of the comparator 30 drops to the voltage of Va0. After the reference voltage (Vb) is higher than the voltage of Va0, the comparator 30 enters the low status.

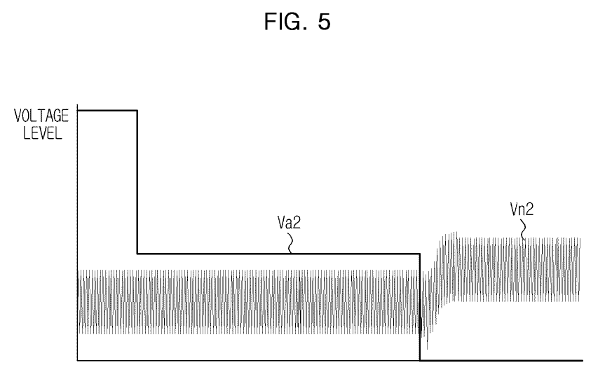

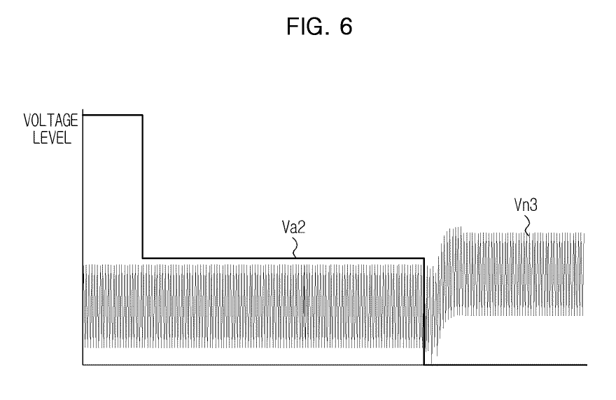

Except for the exemplary cases of FIGS. 5 and 6 in which the second and third noises having voltage differences of 300 mV and 400 mV are applied to the simulation result, the cases of FIGS. 5 and 6 are tested under the same condition as FIG. 4.

As a result, if the second noise (Vn2) having a voltage difference 300 mV and the third noise (Vn3) having a voltage difference 400 mV are applied to the improved circuit as illustrated in FIGS. 5 and 6, the operations of the comparator 30 is not affected by the second and third noises, because the second and third noises are not higher than the temperature-measurement voltage (Va2).

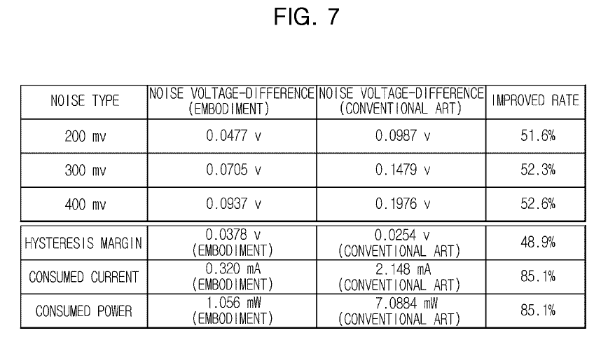

The characteristic-testing results of the improved circuit and the conventional circuit are illustrated in the table 1 of FIG. 7. In this case, except for the stabilization circuit 50 (FIG. 1) of the improved circuit and the functional elements of the circuit, it is assumed that the conventional circuit is identical with the present general inventive concept.

As illustrated in the table, considering the consumption current of the conventional circuit is about 2.14 mA and the consumption power of the conventional circuit is 7.0884 mW, the consumption current and the consumption power can be reduced by about 85% in an embodiment of the present general inventive concept.

If the first noise having a peak-to-peak voltage of 200 mV, the second noise having a peak-to-peak voltage of 300 mV, and the third noise having a peak-to-peak voltage of 400 mV are applied to the conventional circuit, the respective noises may encounter erroneous operations of the comparator 30, and the improved circuit is not affected by the respective noises, and can be normally operated.

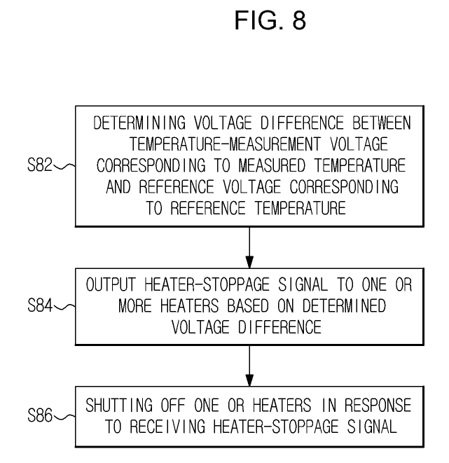

FIG. 8 is a flowchart illustrating a method to prevent overheating of an inkjet image forming apparatus according to an embodiment of the present general inventive concept. Referring to FIGS. 1 and FIG. 8, in operation S82, a voltage difference between a temperature-measurement voltage (Va) corresponding to a measured temperature and a reference voltage (Vb) corresponding to a reference temperature is determined, for example, by a comparator 30. In operation S84, a heater-stoppage signal to one or more heaters based on the determined voltage difference is output, for example, by the comparator 30. In operation S86, the one or more heaters is shutoff in response to receiving the heater-stoppage signal.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, the inkjet image forming apparatus according to various embodiments of the present general inventive concept prevents erroneous operations from being generated in a thermal shutdown circuit of a printer head when noise is received.

The inkjet image forming apparatus minimizes power consumed by additional elements to prevent erroneous operations from being generated in the thermal shutdown circuit, resulting in reduction of total power consumption.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An inkjet image forming apparatus, comprising:
a thermal shutdown circuit to output a heater control signal to control an operation of a heater contained in a head chip according to a temperature-measurement result of the head chip; and
a stabilization circuit to restrict noise induced in the thermal shutdown circuit, and to stabilize operations of the thermal shutdown circuit.

2. The apparatus according to claim 1, wherein the stabilization circuit is mounted to a power-supply line connected between a power-supply unit of the thermal shutdown circuit and a ground terminal.

3. The apparatus according to claim 2, wherein the stabilization circuit comprising:
a circuit element to serve as a current source and a resistor.

4. The apparatus according to claim 3, wherein the circuit element comprises:
at least one PMOSFET;
a gate of to receive a power-supply voltage of the thermal shutdown circuit; and
an additional bias voltage.

5. The apparatus according to claim 4, wherein:
the bias voltage is applied to a comparator to compare a temperature-measurement voltage with a reference voltage in the thermal shutdown circuit.

6. The apparatus according to claim 4, wherein the bias voltage is less than the power-supply voltage and is higher than a minimum turn-on voltage of the PMOSFET.

7. The apparatus according to claim 4, wherein if a plurality of PMOSFETS are connected to a plurality of power-supply lines sharing the power-supply voltage, respectively, the bias voltage is decided to implements a same current signal flowing in the PMOSFETs connected to the power-supply lines.

8. The apparatus according to claim 4, wherein the thermal shutdown circuit comprises:
a temperature-measurement unit to generate a temperature-measurement voltage using first and second temperature-measurement resistors serially connected to a first power-supply line connected between the power-supply voltage and the ground terminal;
a reference-voltage setup unit to generate a reference voltage using first and second voltage-division resistors serially connected to a second power-supply line connected between the power-supply voltage and the ground terminal independent of the first power-supply line; and
a comparator to generate a heater-stoppage signal according to a difference between the temperature-measurement voltage of the temperature-measurement unit and the reference voltage of the reference-voltage setup unit,
in which the circuit element is connected to the first and second power-supply lines.

9. The apparatus according to claim 8, wherein the thermal shutdown circuit further comprises:
a hysteresis-characteristic unit to receive an output signal of the comparator as a feedback signal, and to adjust the reference voltage, and
the circuit element extends a hysteresis margin associated with the reference voltage such that the hysteresis margin is determined by the hysteresis-characteristic unit.

10. An inkjet image forming apparatus, comprising:
a thermal shutdown circuit to generate a heater-stoppage signal to stop operations of a heater according to a result of comparison between a temperature-measurement voltage measured by a head-chip equipped with at least one heater and a reference voltage to prevent the head-chip from overheating; and
a stabilization circuit to restrict noise induced in the thermal shutdown circuit, and to stabilize operations of the thermal shutdown circuit.

11. The apparatus according to claim 10, wherein the stabilization circuit further comprises:
a bias-voltage provider to connect a PMOSFET serving as both a current source and a resistor to each of power-supply lines of the thermal shutdown circuit, and to provide a gate of the PMOSFET with a bias voltage applied to the gate of the PMOSFET, in which
the bias-voltage provider provides a same bias voltage for use in the thermal shutdown circuit.

12. An inkjet image forming apparatus, comprising:
a plurality of nozzles;
an ink storage chamber to store ink; and
one or more heaters to heat the ink and eject ink droplets from the plurality of nozzles,
wherein the one or more heaters shutoff when a temperature-measurement voltage is higher than a reference voltage.

13. A method to prevent overheating of an inkjet image forming apparatus, the method comprising:
determining a voltage difference between a temperature-measurement voltage corresponding to a measured temperature and a reference voltage corresponding to a reference temperature;
output a heater-stoppage signal to one or more heaters based on the determined voltage difference; and
shutting off the one or more heaters in response to receiving the heater-stoppage signal.
